(19) United States
(12) Patent Application Publication
(10) Pub. No.: US 2011/0198275 A1
(43) Pub. Date: Aug. 18, 2011

(54) Manual foot actuated/solar power - air compressor air pressure driven, emergency reverse osmosis water purification system

(75) Inventor: Edwin M. Hayes, Greenehaven, AZ (US)

(73) Assignee: Edwin M. Hayes, Greenehaven, AZ (US)

(21) Appl. No.: 12/658,965

(22) Filed: Feb. 17, 2010

(51) Int. Cl. C02F 1/44

(52) U.S. Cl. 210/251; 210/321.6; 210/257.2

(57) ABSTRACT

A semi-portable water purification system utilizing, a foot actuated or air compressor pumping unit, a reverse osmosis unit, optional post filter for removing odor and color, and other contaminants from a water source. The foot/compressor operated pumping units feed compressed air into a high-pressure tank which source water has been fed into to supply the necessary water pressure for the reverse osmosis membrane. The system further prolongs the efficiency of the source water by simply recycling it a number of times prior to disposal.

### REFERENCES CITED

### Referenced By

### U.S. Patent Documents

| | | |
|---|---|---|
| 5,496,466 | March 1996 | Gray |
| 5,589,066 | December 1996 | Gray |
| 5,725,758 | March 1998 | Chace |
| 4,070,280 | January 1978 | Bray |
| 10951 | May 1854 | Miles |
| 108265 | October 1870 | Holman |
| 201516 | March 1878 | Gerson |
| 308509 | November 1884 | McLeod |
| 400301 | March 1889 | Chichester |
| 648043 | April 1900 | Miles |
| 731623 | June 1903 | Russell |
| 3,372,808 | March 1968 | Sabo |
| 3,966,364 | June 1976 | Bachle et al. |
| 4,187,173 | February 1980 | Keefer |
| 4,366,063 | December 1982 | O'Connor |
| 4,609,466 | September 1986 | McCausland et al. |
| 4,759,844 | July 1988 | Lipschultz et al. |
| 4,808,287 | February 1989 | Hark |
| 4,810,388 | March 1989 | Trasen |
| 4,969,991 | November 1990 | Valadez |
| 5,004,535 | April 1991 | Bosko et al. |
| 5,024,770 | June 1991 | Boyd et al. |
| 5,059,317 | October 1991 | Marius et al. |
| 5,154,820 | October 1992 | Solomon |
| 4,070,280 | January 1978 | Bray |

### Foreign Patent Documents

| | | |
|---|---|---|
| 1436111 | June, 1973 | GB |

### Primary Examiner:

### Attorney, Agent or Finn:

### FIELD OF THE INVENTION

The present invention relates to a high pressure manually operated air foot pump, or optional air compressor utilizing solar power, water purification system utilizing air pressure from a high pressure foot actuated pump(s) or air compressor to supply the necessary feed pressure to the reverse osmosis filtration system. Specifically, the present invention relates to purification of water contaminated with normal contamination found in ponds, streams, lakes, wells, canals, etc. some chemical contaminates can also be removed depending on the optional post filters added to the system. This invention also incorporates the use of recycling the bypass/waste water, passing exiting from the reverse osmosis system to substantially reduce the amount of initial source water needed to produce a desired amount of pure water.

This invention also incorporates the use of air pressure to supply the pressure needed to drive the feed water storing energy, which will substantially reduce the need to keep manually applying or pumping compressed air for the production of purified water. In addition when using the optional air compressor, which is powered via a 12-volt battery (recharged using a solar panel(s)), needs only to be re-pressurized when the pressure level in the pressure tank drops to 40 psi or lower.

### BACKGROUND OF THE INVENTION

Prior manual reverse osmosis filters, typically utilize some form of hand pump combined with pistons to force or push feed water to the membrane housing. Since water is the object used here it is a liquid. The nature of liquids are that they cannot be compressed, therefore requiring a constant manual pumping of the system to continually force water pressure to the reverse osmosis membrane system. Once the manual pumping ceases source water pressure also ceases therefore halting the production of desired purified water.

This air pressure system that is powered by pumping a manually operated high pressure foot air pump, or using the optional air compressor system, pressurizes a feed water tank which retains a feed water pressure for a period of time without continual pumping, since it is driven by compressed air in the said pressurized feed tank forcing the feed water to the membrane system. The high pressure tank can be pressurized to 100 psi which will gradually decrease as the feed water is supplied to the membrane system, however the said membrane will continue to function even as low as 40 psi.

### SUMMARY OF THE INVENTION

The present invention alleviates to a great extent the deficiencies of the prior systems by providing pumping systems deriving its required pressure force using high pressure manual foot air pump(s), or a low voltage compressor to pressurize a high pressure air/water tank to provide the pressurized feed water needed to effectively operate the reverse osmosis membrane.

In addition the system is designed using a recycle feature to enhance the productivity or simply require less source water to produce each gallon of pure water, in case of a shortage or diminished water source.

In another aspect of the invention, the air pressure in the high-pressure tank illuminates the need for continual pumping to produce needed water pressure to operate the reverse osmosis membrane system for the production of pure water.

In addition the, system may as an option include post filters, including however not restricted to carbon adsorption units, for further reducing the level of contaminants in the purified output water.

### BRIEF DESCRIPTION OF THE DRAWING

FIG. 1 is a block diagram of the components of a manual high air pressure foot driven reverse osmosis water purification system according to one embodiment of the present invention.

FIG. 2 is a block diagram of the optional low voltage air compressor driven by the use of a battery, which is recharged using solar panel(s).

### DETAIL DESCRIPTION OF THE INVENTION

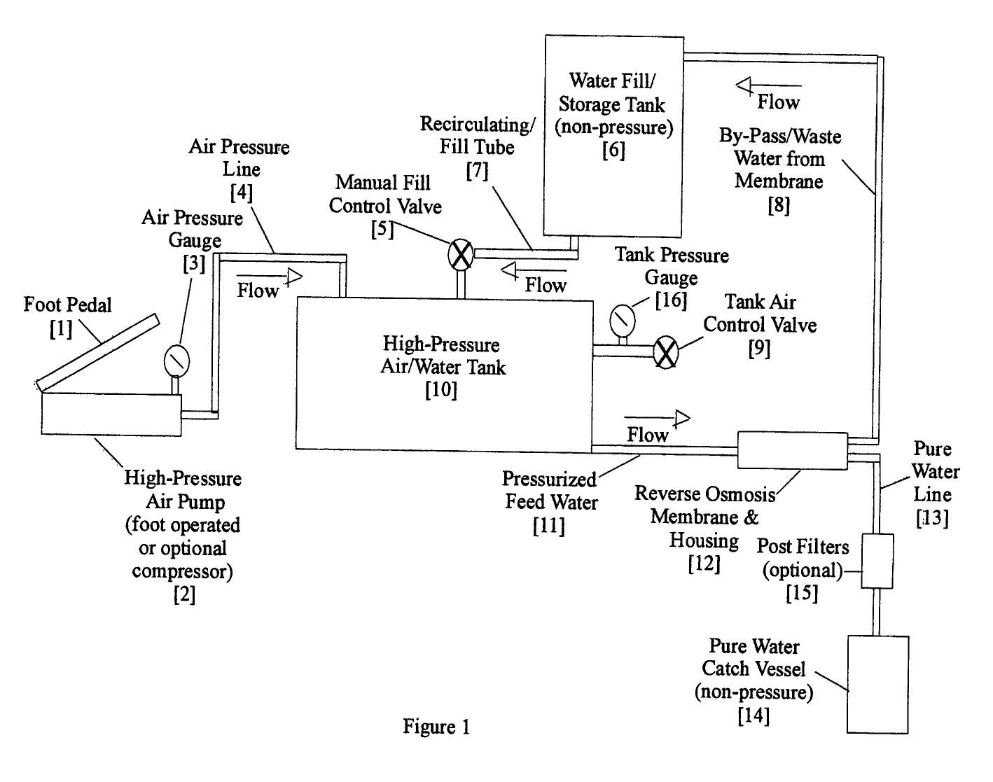

As illustrated in FIG. 1, the water purification system of the present invention has five principal components: (1) a high pressure manually operated foot pump(s) [#2], (2) a high pressure air/water feed tank [#10], (3) a reverse osmosis filtration membrane with housing [#12] along with optional post filters, (4) a re-circulation tank [#6], and (5) a pure water catch vessel [#14].

Contaminated water is placed in a recycling storage tank [#6], then by opening the manual control valve [#5] from the said recycle storage tank along with the manual air control valve [#9] feed water is fed into the high pressure air/water tank [#10] which in turn will provide feed water to the reverse osmosis membrane purification system [#12]. Once the recycling storage water tank is transferred into the high-pressure tank [#9], the manual fill control valve [#5] is closed first followed by closing of the high-pressure tank air control valve. At this point the foot pedal [#1] on the high pressure air pump [#2] can be utilized to pressurize the high pressure air/water tank [#10] up to 120 psi watching the air pressure gauge [#3] to provide the pressurized feed water to the reverse osmosis filtration system [#11]. At the same time by-pass/waste water from the membrane [#11] is automatically deposited back into the recycled storage tank [#6] at the same time pure water is deposited from the membrane [#11] into the pure water storage vessel [#14]. This cycle is repeated until the desired amount of pure water is produced. Using optional post filters [#15] it can be tailored for removal of a specific contaminant type, or a broad spectrum of contaminants.

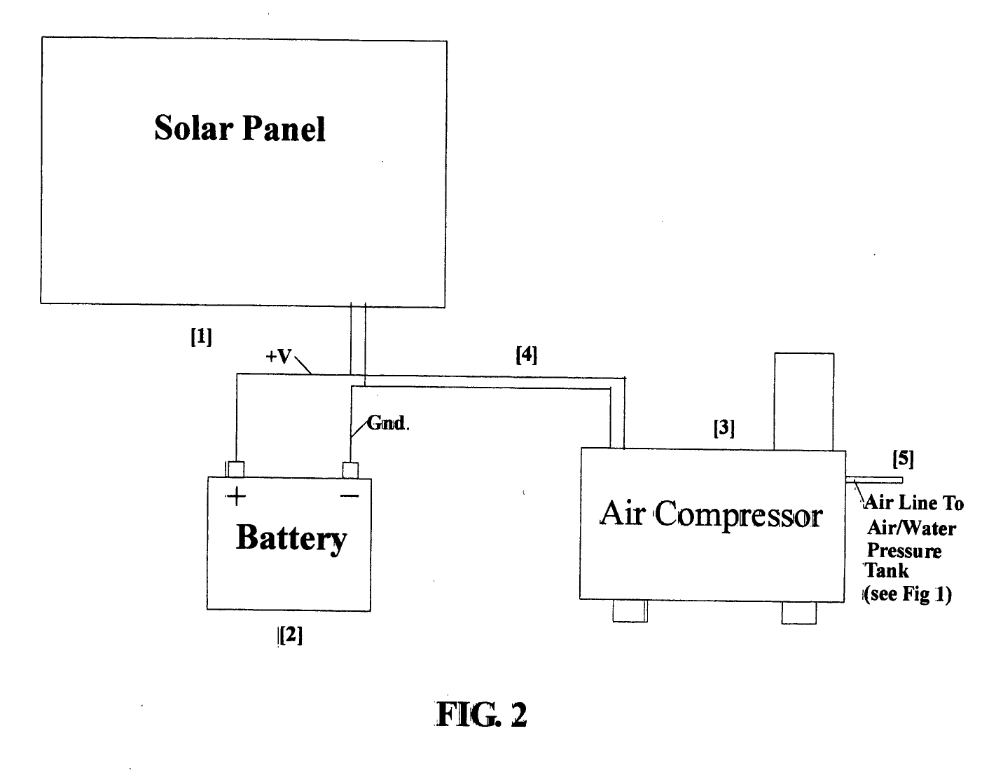

As illustrated in FIG. 2, the needed supply of air pressure sent to the pressurized air/water tank is supplied by a low voltage air compressor, [3] in place of the manually driven foot pump(s) illustrated in FIG. 1). The compressor is powered utilizing a battery [2], which is recharged by use of solar panel(s) [1]. The connection to the pressure air/water tank [5] is exactly the same as connection of the foot operated pump(s).

A reverse osmosis membrane [#11] removes contaminants from the feed water as it passes through the membrane under pressure to the permeate output [#14]. The reverse osmosis unit, depending on the type of membrane used, serves to remove up to 99% of mono and polyvalent ions, particles, microorganisms, and organics 300 molecular weight and larger.

What is claimed is new and desired to be protected by Letters Patents to the United States is:

1. An emergency water purification system, comprising of:
a reverse osmosis filter system having a pressurized feed water input, a purified water output and a by-pass/waste water output; a foot actuated pumping system comprising: (A) an air pumping section for manually pressurizing feed water contained within a high pressure tank, to supply adequate water pressure for operation of the reverse osmosis membrane, said feed water pumping section includes a manual foot high pressure air foot pump feeding a high pressure tank partially filled with contaminated/source water to pressurize the feed water for the reverse osmosis membrane with enough pressure to effectively produce pure water. (B) a by-pass/waste water feed line from the stated reverse osmosis membrane housing connected to a non-pressurized storage tank used for both filling the high pressure tank, as well as recycling of the by-pass water from said membrane for enhancement of efficiency, particularly if the source water is in short supply. (C) A line supplying purified water from the said membrane housing to a catch vessel, with the option of other filters, such as, activated charcoal etc. between said membrane and the purified water catch vessel. (D) In place of compressing the air using the foot pump(s), a low voltage air compressor powered by a battery/solar panel system is optional utilizing the foot pump(s) as a backup system.

2. The pressurized system of claim 1, wherein said system is constructed such that feed water enters said high pressure feed tank through a manually operated valve from the stated recycle non-pressurized storage tank into the said high pressure feed tank. The feed water high-pressure tank is then pressurized using either the manual high-pressure foot pump(s) or the low voltage air compressor, until the desired pressure is registered on the pressure gauge. The source or said feed water then exits said high pressure feed water tank through a pressurized feed line into said reverse osmosis membrane housing input connection. The by-pass/waste water is then sent through the said by-pass/waste water line back to the said recycle/fill tank to be recycled again, at the users discretion. The said purified water from said reverse osmosis membrane housing is then deposited into a catch vessel either directly from the said membrane or passing through optional filters.
